(19) United States
(12) Patent Application Publication
(10) Pub. No.: US 2021/0091402 A1
(43) Pub. Date: Mar. 25, 2021

(54) MULTI-LAYER BATTERY CONFIGURATIONS

(71) Applicant: Apple Inc., Cupertino, CA (US)

(72) Inventor: Yuriy Y. Londarenko, Scotts Valley, CA (US)

(73) Assignee: Apple Inc., Cupertino, CA (US)

(21) Appl. No.: 16/575,949

(22) Filed: Sep. 19, 2019

(51) Int. Cl. H01M 10/04; H01M 2/08

(52) U.S. Cl. CPC H01M 10/0468; H01M 2/08

(57) ABSTRACT

Rechargeable battery cells according to embodiments of the present technology may include a housing including a first conductive segment operable at anode potential, and a second conductive segment operable at cathode potential. The housing may include a gasket positioned between the first conductive segment and the second conductive segment and configured to hermetically seal the housing. The battery cells may also include an electrode stack. The electrode stack may include a cathode current collector having a cathode active material extending across a first surface of the cathode current collector. The cathode current collector may be characterized by at least two pleats. The electrode stack may also include an anode current collector having an anode active material extending across a first surface of the anode current collector. The anode current collector may be characterized by at least two pleats.

### TECHNICAL FIELD

The present technology relates to batteries. More specifically, the present technology relates to battery component configurations.

### BACKGROUND

Batteries are used in many devices. As increased energy density is sought in reduced form factors, device configurations and coupling may cause challenges.

### SUMMARY

Rechargeable battery cells according to embodiments of the present technology may include a housing including a first conductive segment operable at anode potential, and a second conductive segment operable at cathode potential. The housing may include a gasket positioned between the first conductive segment and the second conductive segment and configured to hermetically seal the housing. The battery cells may also include an electrode stack. The electrode stack may include a cathode current collector having a cathode active material extending across a first surface of the cathode current collector. The cathode current collector may be characterized by at least two pleats. A first section of a second surface of the cathode current collector opposite the first surface of the cathode current collector may contact a second section of the second surface of the cathode current collector proximate at least one pleat. The electrode stack may also include an anode current collector having an anode active material extending across a first surface of the anode current collector. The anode current collector may be characterized by at least two pleats. A first section of a second surface of the anode current collector opposite the first surface of the anode current collector may contact a second section of the second surface of the anode current collector proximate at least one pleat.

In some embodiments, the cathode current collector and the anode current collector may each be characterized by an even number of pleats. The first section of the cathode current collector and the second section of the cathode current collector may be interleaved within a pleat of the anode current collector. The first section of the anode current collector and the second section of the anode current collector may be interleaved within a pleat of the cathode current collector vertically offset from the pleat of the anode current collector within which the first section of the cathode current collector and the second section of the cathode current collector are interleaved. The first conductive segment of the housing and the second conductive segment of the housing may each be characterized by a flat base and a sidewall extending orthogonally to the flat base and further extending continuously about the flat base.

The first conductive segment of the housing and the second conductive segment of the housing may be characterized by an arcuate exterior profile. The first conductive segment of the housing may be characterized by an outer radial dimension different from the second conductive segment of the housing. The first section of the anode current collector, the second section of the anode current collector, the first section of the cathode current collector, the second section of the cathode current collector, the flat base of the first conductive segment, and the flat base of the second conductive segment may extend substantially parallel to one another. The anode current collector and the cathode current collector may each be characterized by a first end and a second end opposite the first end. The first end of the anode current collector may be electrically coupled with the first conductive segment of the housing. The second end of the cathode current collector may be electrically coupled with the second conductive segment of the housing. The cells may also include a separator extending continuously between the anode active material and the cathode active material along each pleat of the electrode stack. The electrode stack may be characterized by a notch formed at each pleat of the electrode stack. The second surface of at least one of the anode current collector or the cathode current collector may be at least partially passivated or coated with an electrically insulating material.

Some embodiments of the present technology may encompass rechargeable battery cells. The cells may include a button-cell housing including a first conductive segment, a second conductive segment, and a gasket positioned between the first conductive segment and the second conductive segment. The gasket may be configured to hermetically seal the button-cell housing. The cells may include an electrode stack a cathode current collector having a cathode active material extending across a first surface of the cathode current collector. The cells may include an anode current collector having an anode active material extending across a first surface of the anode current collector. The cells may include a separator positioned between the cathode active material and the anode active material. The electrode stack may be folded at least twice along a longitude of the electrode stack and may be seated between the first conductive segment and the second conductive segment of the button-cell housing.

In some embodiments a notch may be formed through the electrode stack at each fold of the electrode stack. The anode current collector and the cathode current collector may each be characterized by a first end and a second end opposite the first end. The first end of the anode current collector may be electrically coupled with the first conductive segment of the button-cell housing. The second end of the cathode current collector may be electrically coupled with the second conductive segment of the button-cell housing. The first conductive segment of the button-cell housing and the second conductive segment of the button-cell housing are each characterized by a flat base and a sidewall extending orthogonally to the flat base and further extending continuously about the flat base. The first conductive segment of the button-cell housing and the second conductive segment of the button-cell housing may be characterized by an arcuate exterior profile. The first conductive segment of the button-cell housing may be characterized by an outer radial dimension different from the second conductive segment of the button-cell housing.

A first section of a second surface of the cathode current collector opposite the first surface of the cathode current collector may contact a second section of the second surface of the cathode current collector proximate at least one fold of the electrode stack. A first section of a second surface of the anode current collector opposite the first surface of the anode current collector may contact a second section of the second surface of the anode current collector proximate at least one fold of the electrode stack vertically offset from the at least one fold of the electrode stack proximate which the first section of the cathode current collector contacts the second section of the cathode current collector. A second surface opposite the first surface of at least one of the anode current collector or the cathode current collector may be at least partially passivated or coated with an insulative material.

Some embodiments of the present technology may encompass rechargeable battery cells. The cells may include a button-cell housing including a first conductive segment, a second conductive segment, and a gasket positioned between the first conductive segment and the second conductive segment. The gasket may be configured to hermetically seal the button-cell housing. The cells may include an electrode stack. The electrode stack may include a cathode current collector having a cathode active material extending across a first surface of the cathode current collector. The cathode current collector may be characterized by at least two folds. A first section of a second surface of the cathode current collector opposite the first surface of the cathode current collector may contact a second section of the second surface of the cathode current collector proximate at least one fold. The electrode stack may include an anode current collector having an anode active material extending across a first surface of the anode current collector. The anode current collector may be characterized by at least two folds. A first section of a second surface of the anode current collector opposite the first surface of the anode current collector may contact a second section of the second surface of the anode current collector proximate at least one fold.

Such technology may provide numerous benefits over conventional technology. For example, the present batteries may be characterized by increased energy density by improving space efficiency within the battery cell. Additionally, the batteries may facilitate electrode connections within the battery enclosure due to the continuous current collector designs. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a schematic cross-sectional view of battery cell materials according to some embodiments of the present technology.

FIG. 2 shows a schematic elevation view of battery cell materials according to some embodiments of the present technology.

FIG. 3 shows a schematic cross-sectional elevation view of a battery cell according to some embodiments of the present technology.

FIG. 4 shows a schematic plan view of battery cell materials according to some embodiments of the present technology.

FIG. 5 shows a schematic cross-sectional plan view of battery cell materials according to some embodiments of the present technology.

FIG. 6 shows a schematic partial view of battery cell materials according to some embodiments of the present technology.

Several of the figures are included as schematics. It is to be understood that the figures are for illustrative purposes, and are not to be considered of scale or proportion unless specifically stated to be of scale or proportion. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Batteries, battery cells, and more generally energy storage devices, are used in a host of different systems. In many devices, the battery cells may be designed with a balance of characteristics in mind. For example, including larger batteries may provide increased usage between charges, however, the larger batteries may require larger housing, or increased space within the device. As device designs and configurations change, especially in efforts to reduce device sizes, the available space for additional battery components may be constrained. These constraints may include restrictions in available volume as well as the geometry of such a volume.

Stacked battery cell configurations having multiple cells for conventional liquid-electrolyte cells and solid-state cells often include adhesive layers to construct the stacks. Additionally, the conventional structures may include complex interconnect structures to connect the cells. These additional layers, in a given form factor, reduce energy density of the battery produced by reducing the volume available for electrode active materials. Conventional devices that have or include these structures often accept the capacity losses due to additional components incorporated within the device.

For example, button-cell batteries often may be primary or non-rechargeable batteries. Primary batteries may allow increased thickness of electrodes, as reversing the electrochemical process may not be performed. For lithium-ion or other rechargeable battery designs, thicker electrodes may reduce diffusivity and utilization, and thus many lithium-ion batteries include stacks of electrodes. However, such a stack may be less efficient for a button-cell design because the internal area occupied by interconnects or adhesives may reduce the energy density for a given cell size. Some button-cell designs may incorporate a jelly roll or wound type of cell, which may be positioned within the cell structure. However, cell scaling with these wound cells may be limited as the jelly roll may be limited to a certain length to be maintained, which may not accommodate smaller button-cell or other housing geometries, and may extend within less volume of the cell housing, further reducing the energy density of the cell.

The present technology may overcome these issues, however, by providing a configuration by which one or more continuous current collector structures may be used, which may reduce additional layers and interconnect requirements. Additionally, the folded or pleated structure of the electrode stack may maximize internal volume usage within the battery cells in some embodiments. After illustrating an exemplary cell that may be used in embodiments of the present technology, the present disclosure will describe battery designs having a current collector structure for use in a variety of devices in which battery cells may be used.

Although the remaining portions of the description will reference lithium-ion batteries, it will be readily understood by the skilled artisan that the technology is not so limited. The present techniques may be employed with any number of battery or energy storage devices, including other rechargeable and primary battery types, as well as secondary batteries, or electrochemical capacitors. Moreover, the present technology may be applicable to batteries and energy storage devices used in any number of technologies that may include, without limitation, phones and mobile devices, watches, glasses, bracelets, anklets, and other wearable technology including fitness devices, handheld electronic devices, laptops and other computers, motor vehicles and other transportation equipment, as well as other devices that may benefit from the use of the variously described battery technology.

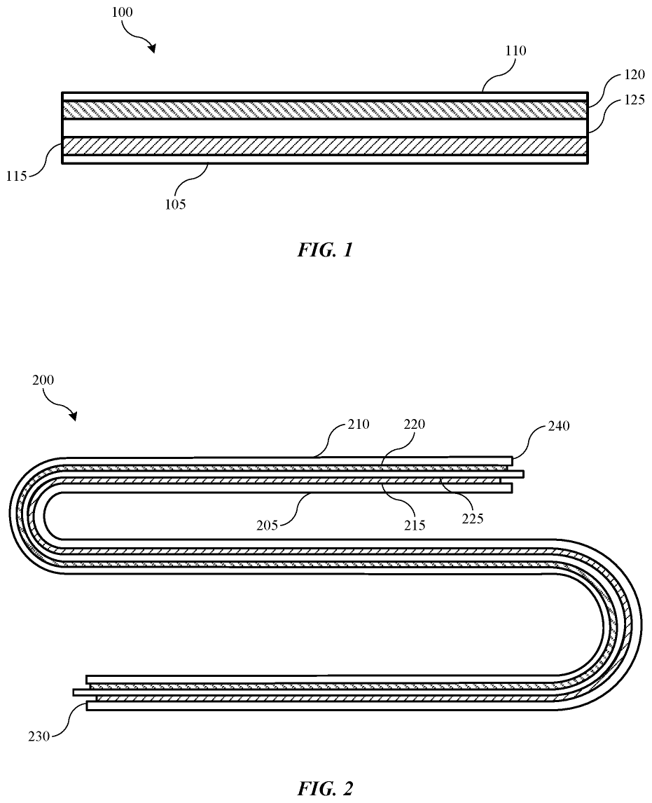

FIG. 1 depicts a schematic cross-sectional view of materials for an energy storage device or battery cell 100 according to embodiments of the present technology. Battery cell 100 may be or include an electrode stack, and may be one of a number of stacks coupled together to form a battery structure. As would be readily understood, the layers are not shown at any particular scale, and are intended merely to show the possible layers of cell material of one or more cells that may be incorporated into an energy storage device. In some embodiments, as shown in FIG. 1, battery cell 100 includes a first current collector 105 and a second current collector 110. In embodiments one or both of the current collectors may include a metal or a non-metal material, such as a polymer or composite that may include a conductive material. The first current collector 105 and second current collector 110 may be different materials in embodiments. For example, in some embodiments the first current collector 105 may be a material selected based on the potential of an anode active material 115, and may be or include copper, stainless steel, or any other suitable metal, as well as a non-metal material including a polymer. The second current collector 110 may be a material selected based on the potential of a cathode active material 120, and may be or include aluminum, stainless steel, or other suitable metals, as well as a non-metal material including a polymer. In other words, the materials for the first and second current collectors can be selected based on electrochemical compatibility with the anode and cathode active materials used, and may be any material known to be compatible.

In some instances the metals or non-metals used in the first and second current collectors may be the same or different. The materials selected for the anode and cathode active materials may be any suitable battery materials operable in rechargeable as well as primary battery designs. For example, the anode active material 115 may be silicon, graphite, carbon, a tin alloy, lithium metal, a lithium-containing material, such as lithium titanium oxide (LTO), or other suitable materials that can form an anode in a battery cell. Additionally, for example, the cathode active material 120 may be a lithium-containing material. In some embodiments, the lithium-containing material may be a lithium metal oxide, such as lithium cobalt oxide, lithium manganese oxide, lithium nickel manganese cobalt oxide, lithium nickel cobalt aluminum oxide, or lithium titanate, while in other embodiments the lithium-containing material can be a lithium iron phosphate, or other suitable materials that can form a cathode in a battery cell.

The first and second current collectors as well as the active materials may have any suitable thickness. A separator 125 may be disposed between the electrodes, and may be a polymer film or a material that may allow lithium ions to pass through the structure while not otherwise conducting electricity. Active materials 115 and 120 may additionally include an amount of electrolyte in a completed cell configuration, which may be absorbed within the separator 125 as well. The electrolyte may be a liquid including one or more salt compounds that have been dissolved in one or more solvents. The salt compounds may include lithium-containing salt compounds in embodiments, and may include one or more lithium salts including, for example, lithium compounds incorporating one or more halogen elements such as fluorine or chlorine, as well as other non-metal elements such as phosphorus, and semimetal elements including boron, for example.

In some embodiments, the salts may include any lithium-containing material that may be soluble in organic solvents. The solvents included with the lithium-containing salt may be organic solvents, and may include one or more carbonates. For example, the solvents may include one or more carbonates including propylene carbonate, ethylene carbonate, ethyl methyl carbonate, dimethyl carbonate, diethyl carbonate, and fluoroethylene carbonate. Combinations of solvents may be included, and may include for example, propylene carbonate and ethyl methyl carbonate as an exemplary combination. Any other solvent may be included that may enable dissolving the lithium-containing salt or salts as well as other electrolyte component, for example, or may provide useful ionic conductivities, such as greater than or about 5-10 mS/cm.

Although illustrated as single layers of electrode material, battery cell 100 may be any number of layers. Although the cell may be composed of one layer each of anode and cathode material as sheets, the layers may also be formed into any form such that any number of layers may be included in battery cell 100. For embodiments which include multiple layers, tab portions of each anode current collector may be coupled together, as may be tab portions of each cathode current collector, although one or more of the current collectors may be a continuous current collector material as will be described below. Once the cell has been formed, a pouch, housing, or enclosure may be formed about the cell to contain electrolyte and other materials within the cell structure. Terminals may extend from the enclosure to allow electrical coupling of the cell for use in devices, including an anode and cathode terminal. The coupling may be directly connected with a load that may utilize the power, and in some embodiments the battery cell may be coupled with a control module that may monitor and control charging and discharging of the battery cell. When multiple cells are stacked together, electrode terminals at anode potential may be coupled together, as may be electrode terminals at cathode potential. These coupled terminals may then be connected with the terminals on the enclosure as noted above.

The structure of battery cell 100 may also illustrate the structure of a solid-state battery cell, which may include anode and cathode materials as well as current collectors as noted previously. A difference between the solid-state design and liquid-electrolyte design previously explained is that in addition to not including electrolyte, separator 125 may be characterized by different materials, although the materials may be characterized by similar properties, such as the ability to pass ions through the material while limiting the passage of electrons. In solid-state configurations, the anode and cathode materials may be any of the materials noted above, as well as additional materials operable as electrode active materials within a solid-state cell. For example, anode materials may include graphene or carbon materials, lithium metal, titanium-containing materials, lithium alloys, as well as other anode-compatible materials. Cathode materials may include lithium-containing oxides or phosphates, as well as other cathode-compatible materials. The inter-electrode material, which may also be noted as 125, may include an electron-blocking material, such as a separator, as well as or alternatively, a solid electrolyte material having ion mobility. Glass materials and ceramics may be used, as well as polymeric materials that may include ion-conducting additives, such as lithium salts. In any instance where the word separator is used, it is to be understood as encompassing both separators and solid electrolytes, which may or may not incorporate separator materials. FIG. 1 is included as an exemplary cell that may be incorporated in batteries according to the present technology. It is to be understood, however, that any number of battery and battery cell designs and materials that may include charging and discharging capabilities similarly may be encompassed by or incorporated with the present technology.

FIG. 2 shows a schematic perspective view of an electrode stack 200 of a battery cell according to some embodiments of the present technology. Electrode stack 200 may include any of the materials or configurations of the cell materials illustrated in FIG. 1, and may include a solid-state cell configuration or a liquid-electrolyte configuration in some embodiments. FIG. 2 illustrates a continuous cell configuration that may produce a folded electrode stack for use in batteries according to some embodiments of the present technology. Unlike conventional technologies that may stack multiple, separate current collectors within the stack and then electrically and/or physically couple the materials, some embodiments of the present technology may utilize a continuous current collector for one or both of the anode or cathode. The schematic view in FIG. 2 includes exemplary components as well as one possible configuration including two continuous electrodes. It is to be understood that the figure illustrates one possible embodiment encompassed by the present technology, which may include a number of configurations and components.

Electrode stack 200 may illustrate similar components as battery cell 100 described above, and may include any of the materials, components, or characteristics described previously. For example, electrode stack 200 may include an anode current collector 205, which may include an anode active material 215 extending across a first surface of the anode current collector. Similarly, a cathode current collector 210 may include a cathode active material 220 extending across a first surface of the cathode current collector. The first surfaces of the anode current collector and the cathode current collector may be facing one another in some embodiments. A separator 225 may be positioned and extend continuously between the anode active material 215 and the cathode active material 220.

As illustrated, electrode stack 200 may be formed in a continuous extension of materials, and in some embodiments, any of the components, including all of the components, may extend continuously from a first end 230 of the electrode stack to a second end 240 of the electrode stack. The continuous extension may then be notched in some embodiments as will be described below, and then a series of pleats or folds may be formed with the electrode stack along a longitude of the electrode stack, and in which either the cathode current collector or the anode current collector may be folded back across itself along a second surface of the current collector opposite the first surface on which the active materials may be disposed. Accordingly, in some embodiments the second surface of the current collectors may be free of active material or other materials in some embodiments. Once the electrode stack pleats have been formed, the electrode stack may be positioned within a housing as discussed below.

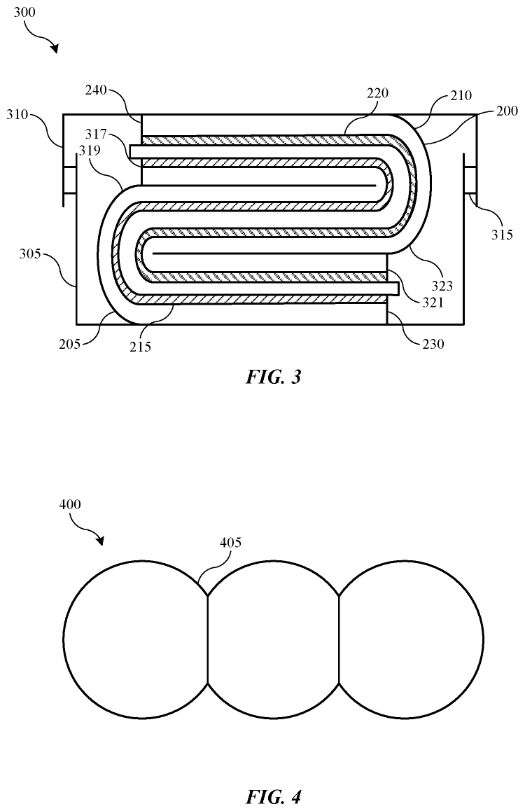

FIG. 3 shows a schematic cross-sectional elevation view of a battery cell 300 according to some embodiments of the present technology. Battery cell 300 may illustrate a button-cell battery housing, although it is to be understood that any number of other housing configurations are similarly encompassed by the present technology, in which electrode stacks as described throughout may accommodate a number of configurations and geometries beyond the non-limiting examples shown. Battery cell 300 may include electrode stack 200 as previously described, which may include any of the components described above for battery cell 100, as well as any other electrode stack materials. It is to be understood that the figure is not produced to any particular scale for any component. For example, electrode active materials may be the thickest component in some embodiments, and the illustrated proportions are not intended to be limiting or necessarily representative of anything more than the structural configuration of battery cells according to some embodiments of the present technology.

The housing of battery cell 300 may include a first conductive segment 305, which may be coupled electrically with the anode current collector 205, and may be operable at anode potential. Additionally, the housing may include a second conductive segment 310, which may be coupled electrically with the cathode current collector 210, and may be operable at cathode potential. It is to be understood that in some embodiments the structure may be reversed, such as by inverting the electrode stack, which may then switch the couplings and operational potentials of the housing sections, which is similarly encompassed by the present technology. A gasket 315 may be positioned between the first conductive segment and the second conductive segment and may facilitate hermetic sealing of the housing and battery cell in some embodiments. The gasket can be any number of components, such as a plastic or elastomer o-ring, a glass or ceramic feedthrough, or any other mechanism that may couple the two housing sections and may also maintain electrical isolation between the two housing sections, which may be operating at opposite potential from one another. Although the housing sections are illustrated as simply overlapping the gasket, it is to be understood that any number of couplings including crimping, welding, or other mechanical couplings, or any other type of coupling are similarly encompassed by the present technology. Accordingly, a number of housing configurations for button-cell battery cells as well as other styles of housing are similarly encompassed.

As illustrated, the folds or pleats of the electrode stack may be complete, in which at least a portion of an interior current collector may contact another portion of the current collector, to limit any gap or spacing between the sections. For example, a first section 317 of anode current collector 205 along the second surface of the current collector may contact a second section 319 of the second surface of the anode current collector 205 near or proximate one of the pleats of the electrode stack. Similarly, a first section 321 of cathode current collector 210 along the second surface of the current collector may contact a second section 323 of the second surface of the cathode current collector 210 near or proximate one of the pleats of the electrode stacks. As illustrated, the contacting sections of the anode current collector and the contacting sections of the cathode current collector may be interleaved within wider pleats of the alternate current collector as illustrated, and may be vertically offset from contacting sections of the alternate current collector.

The anode current collector and/or cathode current collector may extend in a planar fashion across each segment of the electrode stack. For example, as illustrated in the figure, anode current collector 205, as extending through the electrode stack, may be characterized by planar sections extending from an arcuate portion at least partially defining each pleat. Depending on the topography of the active materials, the planar sections of the current collector may extend substantially parallel to one another, accounting for topographical issues, manufacturing tolerances, and other tolerances that may not produce perfect planarity or parallelism between the ends. The planar ends may be connected by the arcuate portion as illustrated, which may extend in a plane orthogonal to the plane along which the current collector ends extend, such as along a thickness of the two electrode stack cell segments. As the electrode stack extends, the current collector may extend back in the opposite direction along the same lateral axis across the vertically extending electrode stack. This pattern may then be repeated as the electrode stack is further extended vertically for any number of pleats or folds.

The cathode current collector 210 may follow a similar extension with a continuous current collector including planar sections across the stacked electrode cell segments, and arcuate portions connecting the planar regions. Again, this may continue for any number of folds or pleats of the electrode stack structure. For example, in some embodiments the electrode stack may include at least two pleats as illustrated, and may include any number of pleats to accommodate a volume of a cell housing, while maintaining an efficient electrode density. In some embodiments the electrode stack may be characterized by an even number of pleats as illustrated, which may then position an exposed portion of the anode current collector at one outer surface of the electrode stack, and may position an exposed portion of the cathode current collector at an opposite outer surface of the electrode stack. This may facilitate coupling of the current collectors with the housing segments as noted above.

For example, a first end 230 of the electrode stack, which may position the first end of the anode current collector as an exterior surface of the electrode stack, may be electrically coupled with the first conductive segment 305 of the housing as illustrated. Similarly, a second end 240 of the electrode stack, which may position the second end of the cathode current collector as an exterior surface of the electrode stack, may be electrically coupled with the second conductive segment 310 of the housing as illustrated. Again, these connections and configurations may be reversed in some embodiments of the present technology as well.

Additionally, in some embodiments the top and bottom materials may be the same electrode current collectors as one another, such as with an odd number of pleats or folds in the electrode stack structure, such as when an entire enclosure in which the battery cell may be disposed may be maintained at the potential of one of the electrodes. These and other configurations are similarly encompassed by the present technology.

As illustrated, in some embodiments, the first conductive segment 305 of the battery cell housing, and the second conductive segment 310 of the battery cell housing may each be characterized by a flat base and a sidewall, which may at least partially extend circumferentially about the flat base, and depending on the sidewall profile, may extend at least partially orthogonally to the flat base, which may define the volume of the battery cell. The flat base of each segment of the housing may extend at least partially parallel to one another, and may extend substantially parallel to each other as well as the first section and second section of each of the anode current collector and cathode current collector, as well as each intervening planar segment as illustrated.

As shown, the first conductive segment 305 of the housing may be maintained at anode potential due to the coupling with the anode current collector, which may be cathode potential in other embodiments. The sidewall of the first conductive segment 305 may at least partially radially define the volume of the battery cell, and may be exposed to the cathode current collector along one or more folds of the electrode stack. Although the electrode stack may be spaced to accommodate a gap, or a spacer may be positioned within the volume, this may reduce the volume occupied by the electrode stack, and may reduce energy density of the battery cell. Accordingly, in some embodiments certain sections of the second surface of the cathode current collector and/or the second surface of the anode current collector may be passivated or rendered inert in one or more ways. For example the second surface may be coated in a dielectric, ceramic, or otherwise electrically insulating material. The second surface may also be passivated by a treatment to render the materials inert. As one non-limiting example, certain sections of the second surfaces may be oxidized or otherwise treated to limit electrical coupling. Other operations may similarly be employed to limit electrical coupling between materials at different potential, while also limiting any loss to volume within the housing.

To facilitate the folding structure, in some embodiments notching may be produced prior to folding the electrode stack. FIG. 4 shows a schematic plan view of an electrode stack 400 according to some embodiments of the present technology. Electrode stack 400 may be similar to any of the previously described electrode stacks, and may include any of the materials, components, or characteristics described previously. As illustrated, in some embodiments the electrode stack may include notches 405 at each position where a fold or pleat is to be produced. The notches 405 may extend through one or more layers, including the entire electrode stack, which may facilitate pleating of the stack in some embodiments.

Additionally, in some embodiments additional shaping may be produced to define a profile of the electrode stack that may maximize occupied volume within the battery cell housing. Although the electrode stack may be characterized by any exterior profile, in some embodiments the exterior profile may be shaped in an arcuate pattern including notches 405, to produce a shape to accommodate an arcuate housing of the battery cell, such as with a button-cell, for example. The arcuate shape may be at least partially circular or elliptical in some embodiments, which may be coordinated with at least one of the housing segments, such as the first conductive segment 305 as previously described, which may at least partially define an outer radial dimension for electrode stack materials in some embodiments.

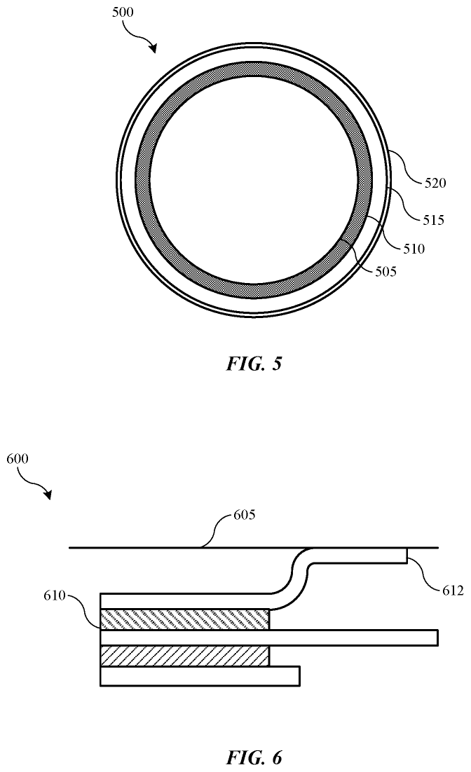

Turning to FIG. 5 is shown a schematic cross-sectional plan view of battery cell 500 materials according to some embodiments of the present technology. The battery cell may illustrate the cell through the top or bottom cover, for example, which may facilitate viewing the internal components. Battery cell 500 may include any number of materials, including any of the materials, components, or configurations previously described. For example, battery cell 500 may include an electrode stack 505 seated or positioned within a first conductive segment 510 of a battery cell housing. A gasket 515 or electrical insulator may be positioned between the first conductive segment 510 and a second conductive segment 520, which may define an exterior of the battery cell in some embodiments. As illustrated, in some embodiments the first conductive segment 510 of the housing and the second conductive segment 520 of the housing may be characterized by an arcuate exterior profile, such as for a button-cell battery in some embodiments. The two segments may be characterized by different outer and/or inner radial dimensions, which may facilitate coupling the segments with gasket 515, while maintaining the two segments of the housing electrically isolated from one another.

Although illustrated with a gap between the electrode stack 505 and the first conductive segment 510 of the housing, this gap may be minimized in some embodiments of the present technology. Button-cell batteries may include additional spacers, or some electrode stacks may include additional interconnects, such as coupling electrode tabs for a number of cells.

Additionally, unlike the direct current collector coupling according to some embodiments of the present technology, some conventional cells may include a conductive jog or extension from the electrode of the battery cell extending to the cell housing. Some conventional cells may also include a spring on one or more of the housing segments, such as a wave spring or a Belleville washer, to compressibly contact the electrode current collector and couple the components. Any of these operations may further reduce the volume occupied by the electrode stack materials, which may limit energy density of the battery cell.

Some embodiments of the present technology may overcome these losses based on the folded electrode stack structure, and the direct coupling with the housing segments. Additionally, because the cell materials may be shaped and folded to accommodate the geometry of the housing as previously described, any gaps between the electrode stack and the housing segments may be minimized. Consequently, in some embodiments of the present technology, the electrode stack may occupy greater than or about 80% of the internal volume defined by the battery cell housing, and in some embodiments may occupy greater than or about 85% of the internal volume, greater than or about 90% of the internal volume, greater than or about 91% of the internal volume, greater than or about 92% of the internal volume, greater than or about 93% of the internal volume, greater than or about 94% of the internal volume, greater than or about 95% of the internal volume, greater than or about 96% of the internal volume, greater than or about 97% of the internal volume, greater than or about 98% of the internal volume, greater than or about 99% of the internal volume, or more of the internal volume. An electrolyte may also be included with these percentages, which may also occupy remaining volume within the cell in some embodiments, although solid electrolyte materials may similarly be utilized in embodiments of the present technology as previously described.

FIG. 6 shows a schematic partial view of battery cell 600 components according to some embodiments of the present technology, and may illustrate one coupling encompassed by the present technology. For example, in some embodiments only a compression coupling may be formed between the housing segments and the current collectors of the electrode stack. In some embodiments as illustrated, a portion of each current collector may be directly coupled with a segment of the battery cell housing. Battery cell 600 may include any number of materials, including any of the materials, components, or configurations previously described, and which may be incorporated in battery cell 600. Battery cell 600 may also illustrate additional aspects of previously described cells according to embodiments of the present technology.

FIG. 6 may illustrate a portion of a housing segment 605 of battery cell 600, and which may be either a first housing segment or a second housing segment as previously discussed. An electrode stack 610 may be included proximate the housing segment, and may show a first end or a second end of a pleated or folded electrode stack. A portion of an outer electrode current collector 612 may be uncoated at an outermost end of the current collector as illustrated, and which may form a tab portion of the electrode current collector. For coupling with the housing segments, one or more current collector tabs may be used, and the alternate current collector may include a similar tab formation for coupling with the other housing segment at the other end of the electrode stack.

When continuous extensions of current collector material are used, such as illustrated, a single connection position may be used at a distal location on the current collectors. For example, the top exposed layer of the electrode stack may include a cathode current collector, for example having a tab coupled with, or extending from, the cathode current collector at this location, which may be a first end of the electrode stack. Similarly, the bottom exposed layer of the electrode stack may include an anode current collector, for example having a tab coupled with, or extending from, the anode current collector at the opposite end of the electrode stack. Although listed as top and bottom, it is to be understood that the orientation may be rotated or reversed while maintaining the relationship of the components of the cell structure. Although not illustrated, these tabs may be coupled with a segment of the housing in any number of ways, including any different type of enclosure or terminal. Because the current collector may be a continuous conductive structure, a tab may be extended from any location along the current collector for coupling with the enclosure or terminal structure. The coupling may include welding, adhesion, or bonding of any type to provide a direct coupling between the components and facilitate operation of the battery cell. By using continuous electrode stacks according to some embodiments of the present technology, improved interconnect structures may be afforded, while maintaining or improving energy density of a battery by reducing additional materials, layers, and components within a battery cell housing.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A rechargeable battery cell comprising:
a housing comprising:
a first conductive segment operable at anode potential,
a second conductive segment operable at cathode potential, and
a gasket positioned between the first conductive segment and the second conductive segment and configured to hermetically seal the housing; and
an electrode stack comprising:
a cathode current collector having a cathode active material extending across a first surface of the cathode current collector, wherein the cathode current collector is characterized by at least two pleats, wherein a first section of a second surface of the cathode current collector opposite the first surface of the cathode current collector contacts a second section of the second surface of the cathode current collector proximate at least one pleat; and
an anode current collector having an anode active material extending across a first surface of the anode current collector, wherein the anode current collector is characterized by at least two pleats, wherein a first section of a second surface of the anode current collector opposite the first surface of the anode current collector contacts a second section of the second surface of the anode current collector proximate at least one pleat.

2. The rechargeable battery cell of claim 1, wherein the cathode current collector and the anode current collector are each characterized by an even number of pleats.

3. The rechargeable battery cell of claim 1, wherein the first section of the cathode current collector and the second section of the cathode current collector are interleaved within a pleat of the anode current collector.

4. The rechargeable battery cell of claim 3, wherein the first section of the anode current collector and the second section of the anode current collector are interleaved within a pleat of the cathode current collector vertically offset from the pleat of the anode current collector within which the first section of the cathode current collector and the second section of the cathode current collector are interleaved.

5. The rechargeable battery cell of claim 1, wherein the first conductive segment of the housing and the second conductive segment of the housing are each characterized by a flat base and a sidewall extending orthogonally to the flat base and further extending continuously about the flat base.

6. The rechargeable battery cell of claim 5, wherein the first conductive segment of the housing and the second conductive segment of the housing are characterized by an arcuate exterior profile, and wherein the first conductive segment of the housing is characterized by an outer radial dimension different from the second conductive segment of the housing.

7. The rechargeable battery cell of claim 5, wherein the first section of the anode current collector, the second section of the anode current collector, the first section of the cathode current collector, the second section of the cathode current collector, the flat base of the first conductive segment, and the flat base of the second conductive segment extend substantially parallel to one another.

8. The rechargeable battery cell of claim 5, wherein the anode current collector and the cathode current collector are each characterized by a first end and a second end opposite the first end, wherein the first end of the anode current collector is electrically coupled with the first conductive segment of the housing, and wherein the second end of the cathode current collector is electrically coupled with the second conductive segment of the housing.

9. The rechargeable battery cell of claim 1, further comprising a separator extending continuously between the anode active material and the cathode active material along each pleat of the electrode stack.

10. The rechargeable battery cell of claim 1, wherein the electrode stack is characterized by a notch formed at each pleat of the electrode stack.

11. The rechargeable battery cell of claim 1, wherein the second surface of at least one of the anode current collector or the cathode current collector is at least partially passivated or coated with an electrically insulating material.

12. A rechargeable battery cell comprising:
a button-cell housing comprising:
a first conductive segment,
a second conductive segment, and
a gasket positioned between the first conductive segment and the second conductive segment and configured to hermetically seal the button-cell housing; and
an electrode stack comprising:
a cathode current collector having a cathode active material extending across a first surface of the cathode current collector,
an anode current collector having an anode active material extending across a first surface of the anode current collector, and
a separator positioned between the cathode active material and the anode active material, wherein the electrode stack is folded at least twice along a longitude of the electrode stack and seated between the first conductive segment and the second conductive segment of the button-cell housing.

13. The rechargeable battery cell of claim 12, wherein a notch is formed through the electrode stack at each fold of the electrode stack.

14. The rechargeable battery cell of claim 12, wherein the anode current collector and the cathode current collector are each characterized by a first end and a second end opposite the first end, wherein the first end of the anode current collector is electrically coupled with the first conductive segment of the button-cell housing, and wherein the second end of the cathode current collector is electrically coupled with the second conductive segment of the button-cell housing.

15. The rechargeable battery cell of claim 12, wherein the first conductive segment of the button-cell housing and the second conductive segment of the button-cell housing are each characterized by a flat base and a sidewall extending orthogonally to the flat base and further extending continuously about the flat base.

16. The rechargeable battery cell of claim 12, wherein the first conductive segment of the button-cell housing and the second conductive segment of the button-cell housing are characterized by an arcuate exterior profile, and wherein the first conductive segment of the button-cell housing is characterized by an outer radial dimension different from the second conductive segment of the button-cell housing.

17. The rechargeable battery cell of claim 12, wherein a first section of a second surface of the cathode current collector opposite the first surface of the cathode current collector contacts a second section of the second surface of the cathode current collector proximate at least one fold of the electrode stack.

18. The rechargeable battery cell of claim 17, wherein a first section of a second surface of the anode current collector opposite the first surface of the anode current collector contacts a second section of the second surface of the anode current collector proximate at least one fold of the electrode stack vertically offset from the at least one fold of the electrode stack proximate which the first section of the cathode current collector contacts the second section of the cathode current collector.

19. The rechargeable battery cell of claim 12, wherein a second surface opposite the first surface of at least one of the anode current collector or the cathode current collector is at least partially passivated or coated with an insulative material.

20. A rechargeable battery cell comprising:
a button-cell housing comprising:
a first conductive segment,
a second conductive segment, and
a gasket positioned between the first conductive segment and the second conductive segment and configured to hermetically seal the button-cell housing; and
an electrode stack comprising:
a cathode current collector having a cathode active material extending across a first surface of the cathode current collector, wherein the cathode current collector is characterized by at least two folds, wherein a first section of a second surface of the cathode current collector opposite the first surface of the cathode current collector contacts a second section of the second surface of the cathode current collector proximate at least one fold; and
an anode current collector having an anode active material extending across a first surface of the anode current collector, wherein the anode current collector is characterized by at least two folds, wherein a first section of a second surface of the anode current collector opposite the first surface of the anode current collector contacts a second section of the second surface of the anode current collector proximate at least one fold.
